(19) United States
(12) Patent Application Publication
(10) Pub. No.: US 2008/0170521 A1
(43) Pub. Date: Jul. 17, 2008

(54) SYSTEM AND METHOD FOR QOS PERFORMANCE IN MULTIHOP NETWORKS

(75) Inventors: Saravanan GOVINDAN, Singapore (SG); Pek Yew Tan, Singapore (SG)

Correspondence Address: DICKINSON WRIGHT PLLC, 1901 L STREET NW, SUITE 800, WASHINGTON, DC, 20036, US

(73) Assignee: Matsushita Electric Industrial Co., Ltd., Osaka (JP)

(21) Appl. No.: 11/955,121

(22) Filed: Dec. 12, 2007

Related U.S. Application Data
(60) Provisional application No. 60/874,733, filed on Dec. 14, 2006.

(51) Int. Cl. H04B 7/00

(52) U.S. Cl. 370/310

(57) ABSTRACT

Systems and methods for adjusting channel access based on contention conditions in a communications network are disclosed. The invention addresses the problem of multihop communications networks with varying contention conditions. Particularly, the invention addresses the channel access for common communications channels of a single or plurality of multihop configurations.

This is a non-provisional application of provisional application No. 60/874,733 filed Dec. 14, 2006, incorporated by reference herein in its entirety.

### FIELD OF THE INVENTION

The present invention pertains to operations of communications networks and, more particularly, it relates to the configuration and management of communications entities in multihop networks.

### DISCLOSURE OF INFORMATION ON PRIOR ART DOCUMENTS

[Prior-Art 1] US 2005/003 6448 A1, “Management of Frame Bursting,” August 2003.

[Prior-Art 2] US 2004/025 8039 A1, “Adaptive Use of Transmit Opportunity,” June 2003.

[Prior-Art 3] US 2003/022 3365 A1, “Class of Dynamic Programming Schedulers,” November 2002.

[Prior-Art 4] US 2003/006 3563 A1, “Class of Computationally Parsimonious Schedulers for enforcing Quality of Service over Packet based AV-centric Home Networks,” February 2002.

[Prior-Art 5] US 2003/002 3469 A1, “System and Method for Ordering Data Messages having Differing Levels of Priority for Transmission over a Shared Communication Channel,” August 2001.

### CROSS-REFERENCE TO RELATED PATENT APPLICATIONS

This application makes reference to the following commonly owned patent applications and/or patents, which are incorporated herein by reference in their entirety for all purposes.

PCT patent application PCT/JP2005/024283 in the name of Saravanan Govindan and Pek Yew Tan, and entitled “Method for Selective Distribution of Communications Infrastructure.”

### BACKGROUND OF THE INVENTION

Wireless technologies have diverse applications. An increasingly popular application is wireless mesh networks. Here, meshes of interconnected communications entities comprise communications networks. The communications entities are connected by means of wireless links, such as those corresponding to IEEE 802.11, IEEE 802.16 and IEEE 802.20 technologies. These wireless meshes serve as the backbone of communications networks for exchanging communications traffic.

In wireless mesh networks, communications entities are interconnected in a mesh framework. As a result, there is a plurality of paths between communicating end-points. There is also a plurality of paths to the communications network controller or gateway. Each communications entity establishes and maintains information on the plurality of paths available. This information is then used for routing communications traffic among the plurality of paths.

[Problems with Mesh]

Wireless mesh networks are characterized by the effectiveness of their control and routing mechanisms. Due to their plurality of paths and distributed nature, wireless mesh networks do not deliver optimal communications performance.

The dynamic nature of wireless links necessitates in each mesh communications entity constantly exchanging and updating control and routing information. This overhead is substantial and drastically reduces the effective communications data rate of the system. In particular, voice over IP (VoIP) and streaming applications suffer excessive delays, losses and other adverse effects from the overhead.

Furthermore, the complexity of the mesh framework makes optimization a tedious and computationally intensive task.

Another problem with wireless mesh networks relates to the modifications of such networks. When communications entities are either added or removed, there is a need for complete update of the entire mesh network. This inhibits changes to the network after initial setup and limits the options for expansion.

[Problem with Mesh Channel Access]

A wireless mesh network is considered as a single aggregation of wireless communications entities without logical or physical divisions. When the mesh network interfaces with a communications network controller or gateway, the access to the controller or gateway is consistent. This is because the large numbers of constantly varying mesh paths between the wireless mesh network and network controller or gateway provide statistical uniformity. Consequently, access to the interface or wireless channel of the network controller or gateway is uniform across the plurality of mesh paths.

### [Multihop Chain Framework]

Due to the complexity and complication of wireless mesh networks, there is an emerging trend towards multihop networks. Here, communications entities of a communications network are organized to operate in a multihop configuration. A plurality of communications entities in a multihop configuration comprises a multihop chain. Multihop chains are then connected to a communications network controller or gateway. So the communications network becomes an aggregation of structured multihop chains comprising communications entities.

The multihop chain organization enhances control, management, security and performance of the communications network. Each multihop chain can be individually managed, configured and coordinated. This configuration also provides for a single path between communications entities in and outside various multihop chains of a communications network. As a result, there is substantial reduction in control overhead. Routing is also simplified due to the constrained paths of multihop chains. Consequently, multihop wireless networks can be designed to support VoIP and streaming applications.

[Problems with Existing Multihops]

However, current designs for multihop configurations are based on applying the same mechanisms of wireless mesh networks, but in a constrained manner. While a cursory examination may conclude that such an approach is appropriate, detailed analyses reveal that multihop configurations have distinct characteristics from wireless mesh networks, which must be considered for optimal design.

### [Problem Between Distinct Multihop Chains]

In a first case, multihop chains differ from wireless mesh networks in that each multihop chain may comprise varying numbers of constituent communications entities. This is because multihop chains are organized for configurations with varying requirements with varying chain length features. Particularly, each multihop chain has a distinct level of contention for access to the wireless channel of the network controller or gateway. This is because each multihop chain comprises distinct numbers of communications entities with distinct access requirements. So the application of uniform wireless mesh network mechanisms to multihop chains overlooks intrinsic distinctions and thus adversely affects communications performance.

### [System-Wide Problem Among Multihop Chains]

In a second case, the internal distinctions in communication and information exchange operations result in multihop chains utilizing varying operation schedules. For example, a first multihop chain may be conducting internal communications during which time a second multihop chain may be conducting communications with the network controller or gateway. As a result, multihop chains have distinctive operations with respect to each other.

The distinctive operations of multihop chains are particularly manifested in their respective access to the communications network controller or gateway. So in a multihop communications network, there are a limited number of multihop chains simultaneously contending for access to the interface or wireless channel of the network controller or gateway. So the application of uniform wireless mesh network mechanisms, in which contention is assumed to be consistent, results in suboptimal channel access.

So if multihop chains are configured without accounting for differences in chain length, they will not be assigned optimal resources to conduct communications with the network controller or gateway. This lack of fairness leads to excessive delays, reduced data rates and unacceptable charging for network services subscribers.

[Prior-Art 1] illustrates a method for selecting the time of request for channel access in wireless local area networks (WLANs). According to the method, requests for transmission opportunities (TXOPs) are sent based on the level of buffered traffic. The aim here is to maximize the outcome from each contention event based on the assumption that contention levels are fixed. This assumption is contrary to multihop networks, in which contention varies based on multihop chain length and multihop chain operation schedules. [Prior-Art 1] is therefore unsuitable to configure and manage multihop networks.

[Prior-Art 2] presents a method for adaptive utilization of TXOPs for either throughput or delay enhancements. This method describes means to adapt TXOPs for efficient operations. However, it does not describe means to adapt TXOPs themselves to handle the dynamic channel access characteristics of multihop networks.

The scheduling method of [Prior-Art 3] attempts to adjust TXOP allocations based on a system of linear programming Performance metrics such as throughput and queue size are optimized under network constraints of delay bounds and channel rates. This method is still insufficient for multihop networks because it fails to account for variations in contention levels.

[Prior-Art 4] illustrates a method for channel access based on flow characteristics. The scheduler mechanism terminates an allocated channel access period if the flow has completed transmission. While the method makes efficient use of allocated channel access opportunities, it does not offer means to efficiently allocate channel access opportunities.

[Prior-Art 5] presents a channel access mechanism based on priority levels in the communications system. This method addresses an issue of system-wide conditions, but it does so for the static case of priority levels. Contention levels, such as those in multihop networks, are dynamic conditions for which this method of passive adjustments is not appropriate.

The prior arts discussed insofar illustrate the lack of existing mechanisms to address the needs of multihop wireless networks. One particular need is that of fairness among multihop chains and their access to the interface or wireless channel of a communications network controller or gateway.

### OBJECTIVE OF THE INVENTION

In view of the above discussed problems, it is the objective of the present invention to provide systems and methods for provisioning communications resource access among a single or plurality of wireless communications entities.

It is another objective of the invention to provide methods for evaluating characteristics of resource contention of a communications network comprising a single or plurality of multihop chain configurations.

It is yet another objective of the invention to provide methods for scheduling resource access of a communications network.

It is another objective of the invention to provide methods for coordinating resource access of a communications network among or within a single or plurality of multihop chain configurations.

It is yet another objective of the invention to provide methods for computing contention characteristics of multihop chain configurations of a communications network.

### SUMMARY OF INVENTION

The present invention addresses the problems relating to managing access to resources of communications networks comprising multihop chain configurations. In particular, the invention addresses the problems of indirect access to resources through a single or plurality of intermediate communications entities. The invention also addresses the problem of coordinating channel access across a plurality of multihop chain configurations.

In its broadest aspect, the present invention provides system for managing access to a communications resource in a communications network comprising, means for monitoring a single or plurality of contention conditions, means for monitoring contention profiles of a single or plurality of communicating entities, and means for calculating resource access parameters, whereby, said calculated resource access parameters are used by a single or plurality of communicating entities to contend for resource access to said communications resource.

In a preferred form of the invention for managing access to a communications resource, said contention conditions comprise number of configurations of communicating entities contending for resource access, number of communicating entities comprising said configurations of communicating entities, operating schedules of said communicating entities, transmission opportunities and transmission characteristics of said communicating entities.

In a preferred form of the invention, said configurations of communications entities comprises multihop configurations.

In another preferred form of the invention for managing access to a communications resource, said communications resource comprises communications channel.

In another aspect, the current invention presents a system for managing resource access to a communications resource in a communications network comprising means for calculating effect of contention conditions on communications performance and means for adjusting resource access parameters based on said calculated effect, whereby, communicating entities contend for resource access to said communications resource with said adjusted resource access parameters.

In a preferred form of the current invention, said communicating entities adjust said resource access parameters to reduce communications response time.

In another preferred form of the current invention, said communicating entities adjust said resource access parameters to increase communications throughput.

Another aspect of the present invention presents a system for managing resource access to a communications resource in a communications network comprising means for calculating contention conditions in said communications network, whereby, said contention conditions comprise direct and indirect contention conditions for resource access to said communications resource.

In a preferred form of the present invention, said calculation of contention conditions comprises parameters of number of configurations of communicating entities contending for resource access and number of communicating entities comprising each of said configurations of communicating entities.

In another aspect of the invention, a system is presented for managing resource access to a communications resource in a communications network comprising means for aggregating contention conditions of a plurality of communications entities contending for said communications resource, whereby said aggregated contention conditions are maintained by a single or plurality of communications entities.

In a preferred form of the invention, said aggregated contention conditions are indicative of direct or indirect contention for said communications resource, whereby resource access parameters are adjusted in relation to the aggregated contention conditions.

### BRIEF DESCRIPTION OF THE DRAWINGS

FIG. 1 illustrates a communications network comprising network controller and wireless communications entities within which the present invention operates.

FIG. 2 depicts a sequence of coordination operations of the invention

FIG. 3 is illustrative of an apparatus of a network controller or wireless communications entity in accordance with the present invention.

FIG. 4 is illustrative of an apparatus of a network controller or wireless communications entity in accordance with the present invention relating to the IEEE 802.11 specifications.

FIG. 5 depicts a message format for messages exchanged in accordance with the present invention for adjusting resource access parameters.

FIG. 6 is representative of a communications network operating in accordance with the present invention relating to the IETF CAPWAP framework.

FIG. 7 illustrates a sequence of operations and protocol exchanges following the invention.

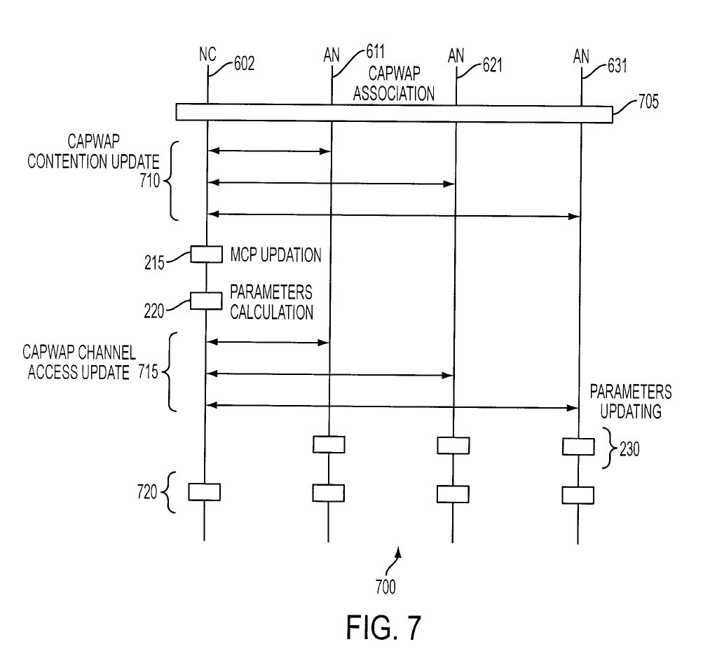

FIG. 8 depicts a message structure in accordance with the invention relating to the IETF CAPWAP protocol.

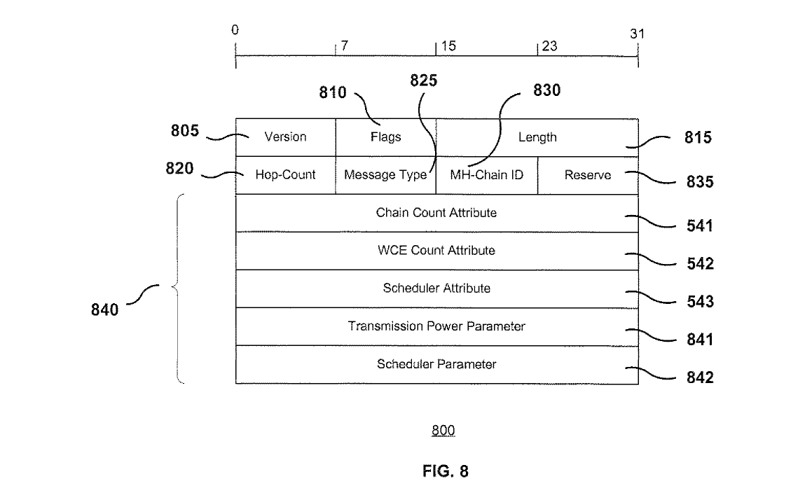

FIG. 9 depicts a flowchart of the sequence of operations performed by anchor nodes and other WCEs in accordance with the present invention.

FIG. 10 depicts a flowchart of the sequence of operations performed by a network controller in accordance with the present invention.

FIG. 11 is representative of a communications network of network cameras operating in accordance with the present invention.

FIG. 12 illustrates a communications network in which one embodiment of the invention manages resource access.

### DETAILED DESCRIPTION OF THE PREFERRED EMBODIMENTS

In the following description, for the purpose of explanation, specific numbers, times, structures and other parameters are set forth in order to provide a thorough understanding of the present invention. However, it will be apparent to those skilled in the art that the present invention may be practiced without these specific details.

### Embodiment 1

### Multihop Contention Profile

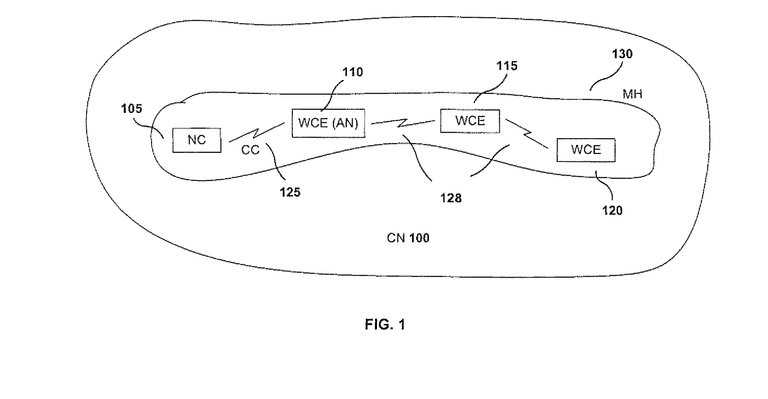

With reference to FIG. 1, a communications network (CN) (100) in accordance with the current invention is illustrated. CN (100) comprises a network controller (NC) (105) and a single or plurality of wireless communications entities (WCE) (110), (115) and (120).

NC (105) is representative of a controller entity capable of coordinating network resources, provisioning and configuring WCEs, such as WCE (110), (115) and (120), and coordinating channel access and communications flows among them. NC may be a communications entity such as access controller, base station, access point, wireless termination point or other wireless communications entity. WCEs are representative of communications devices such as wireless access points and mobile terminals, capable of transmitting and receiving communications traffic. WCEs may be communication entities such as access points, wireless termination points, relay stations, base stations or other wireless communications entities.

In accordance with the current invention for QoS performance in multihop networks, WCEs of a communications network are organized in a multihop configuration, heretofore referred to as multihop chain. Multihop chain (MH) (130) Of CN (100) comprises WCEs (110), (115) and (120). WCEs of MH (130) communicate with NC (105) directly or indirectly through intermediate WCEs. As an example, in FIG. 1, communications between NC (105) and WCE (110) are exchanged directly, whereas communications between NC (105) and WCE (120) are exchanged indirectly via intermediate WCE (110) and WCE (115).

The WCE of a multihop chain that is in direct communications with the network controller is referred to as the anchor node (AN). The anchor node of a multihop chain contends for channel access on behalf of itself and on behalf of other WCEs of the multihop chain. In FIG. 1, WCE (110) is the anchor node for multihop chain MH (130). WCE (110) communicates with NC (105) to exchange its own communications traffic and also to exchange communications traffic on behalf of other WCEs (115) and (120) of MH (130). In one aspect of the invention, a multihop chain comprises a plurality of anchor nodes communicating with a plurality of network controllers.

Multihop chains are also characterized by a single communications path between NC (105) and WCE (110), (115) and (120) comprising the multihop chain MH (130).

WCEs of multihop chains, such as WCE (110), (115) and (120) of MH (130), are communicably coupled with other WCEs by means of wireless or wired communications channels. The communications channels are operative in accordance with technologies comprising Bluetooth, IEEE 802.11, IEEE 802.16, GPRS, WCDMA, CDMA2000, Ethernet and optical fiber. In one aspect of the embodiment, in which WCEs of a multihop chain are representative of access points, wireless termination points, base transceiver stations or relay stations, the WCEs are also communicably with terminal entities such as mobile stations.

NC (105) is communicably coupled with a single or plurality of multihop chains, such as MH (130), by means of wired or wireless communications channels, by either direct means or indirect means through alternative communications entities such as wireless access points or base transceiver stations. The communications channels are operative in accordance with technologies comprising Bluetooth, IEEE 802.11, IEEE 802.16, GPRS, WCDMA, CDMA2000, Ethernet and optical fiber.

WCE (110), (115) and (120) of MH (130) communicate with NC (105) directly or indirectly through intermediate WCEs and communications channels. There exists a common communications channel (CC) (125) between NC (105) and WCEs (110), (115) and (120) of MH (130). As a result, WCEs (110), (115) and (120) of MH (130) will directly or indirectly contend for channel access to the common CC (125) to exchange communications with NC (105). Anchor node, WCE (110), exchanges communications with NC (105) across CC (125) on behalf of constituting WCEs of MH (130).

In accordance with the present invention, NC (105) manages direct and indirect contention for channel access on common CC (125) among multihop chains, such as MH (130), and among WCEs constituting said multihop chains, such as WCE (110), (115) and (120). Channel access on CC (125) is actively managed to deliver QoS performance among multihop chains and among WCEs constituting multihop chains for QoS performance.

Contention for channel access on common CC (125) is managed by utilizing a set of parameters termed as Multihop Contention Profile (MCP). A MCP is representative of the actual level of contention encountered by a multihop chain in a communications network. By this, MCPs account for both direct contention—by anchor nodes of multihop chains, and indirect contention—by WCEs constituting a multihop chain, for channel access on common CC (125). MCPs are regularly reviewed for managing contention.

Parameters comprising MCP for a multihop chain in a communications network are:

1 Number of anchor nodes in the communications network simultaneously contending for channel access to a common communications channel;
2. Number of WCEs in the multihop chain, directly and indirectly, contending for the same channel access;
3. Transmission schedule of multihop chains and constituent WCEs;
4. Communications volume across the common communications channel, this may be history or expected communications volume; and
5. Characteristics of common communications channel, comprising interference levels, signal-to-interference ration (SIR) and signal-to-noise ratio (SNR).

MCPs may comprise alternative or additional parameters representative of the actual level of contention in the communications network.

MCPs for multihop chains are regularly monitored and updated to reflect prevailing network conditions.

Multihop contention profiles are representative of the factors affecting contention for channel access. They are in turn used to manage channel access by means of adjusting channel access parameters for a single or plurality of multihop chains. Channel access parameters comprise resource dedicators such as transmission opportunities (TXOP) for IEEE 802.11 and IEEE 802.16, traffic channels (TRCH) for GSM and transport channels for WCDMA. Channel access parameters are adjusted based on MCPs to deliver QoS performance to multihop chains and constituent WCEs.

In accordance with the invention, channel access parameters for a multihop chain are regularly computed and updated based on its MCP. Equation 1 is an algorithmic presentation for calculation of channel access parameters such as those described earlier;

$$\begin{matrix}{ChP}_{MH \text{-} x} = f ( {MCP}_{MH \text{-} x} ) \\ = f ( {nAN}_{Simul} , {nN}_{MH \text{-} x} ) \\ = ( P 1 \times {nN}_{MH \text{-} x} ) / ( P 2 \times {nAN}_{Simul} )\end{matrix} \qquad Equation 1$$

wherein, ‘ChP_{MH-x}’ represents the channel access parameter being adjusted for multihop chain, ‘MH-x’, and ‘MCP_{MH-x}’ is the multihop contention profile for the same multihop chain

‘f ( )’ is a combinative function comprising the factors affecting contention for channel access.

The parameter ‘nAN_{Simul}’ is representative of the number of anchor nodes of multihop chains simultaneously competing for channel access with “MH-x”. This parameter has a negative relation to ‘ChP_{MH-x}’. So when there are many multihop chains contending for channel access, channel access is adjusted to be shorter so as to reduce channel access delay for all contending multihop chains. This also allows for fairness among contending multihop chains.

The parameter ‘nN_{MH-x}’ is representative of the total number of WCEs comprising ‘MH-x’ that are directly or indirectly contending for channel access. This parameter has a positive relation to ‘ChP_{MH-x}’. So where there are many WCEs, channel access is adjusted to allow each WCE to conduct some communications exchanges with the network controller.

‘P1’ and ‘P2’ are multiplicative constants for ‘nN_{MH-x}’ and ‘nAN_{Simul}’, respectively. These constants are representative of factors such as weights of the contention parameters.

Equation 1 may comprise alternative or additional parameters such as transmission schedule of multihop chains and their constituent WCEs and volume of communications exchanges. In the case of communications exchange, as volume increases, channel access parameters will require to be extended to accommodate greater communications exchanges. So volume of communications exchange has a positive relation to channel access parameters.

In the case of channel characteristics, if channel condition degrades due to interference or other causes, there will be greater contention among multihop chains to exchange communications during the period of communicable channel conditions. So channel characteristics have a negative relation to channel access parameters. In one aspect of the embodiment, some channel characteristics may have positive relation to channel access parameters. For example, signal-to-interference ratio (SIR) and signal-to-noise ratio (SNR) have negative relation to channel access parameters. High values of SIR and SNR denote communicable channel conditions, for which contention levels may be lower.

The parameters of function ‘f ( )’ may also be weighted so as to assign relative degrees of significance in assessing contention for channel access. For example, in Equation 1, the ‘nAN_{Simul}’ parameter may have a weight of 80% while the ‘nN_{MH-x}’ parameter may have a weight of 20%. As a result, channel access parameters are calculated to primarily manage contention among multihop chains. In the case of weighting, ‘P1’ and ‘P2’ are representative of the respective weights.

Based on Equation 1, the anchor node of multihop chain ‘MH-x’ is assigned corresponding resources for channel access to the network controller over the common communications channel.

As a result of adjusting channel access based on actual contention levels in a communications network, WCEs (110), (115) and (120) of MH (130) will be able to exchange communications with NC (105) over the common CC (125). This consequently reduces response times for MH (130) and improves throughput performance.

### Embodiment 2

### Sequence of MCP & Channel Access Updates

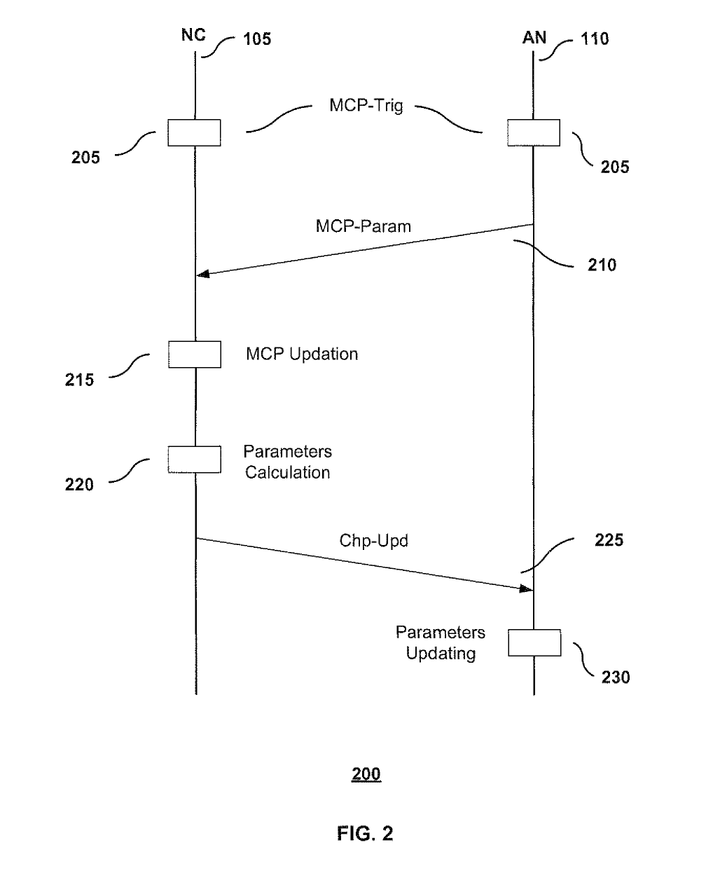

The sequence of operations of channel access adjustments in accordance with the invention is illustrated in FIG. 2. The operative steps of channel access adjustment (200) are conducted between an anchor node “AN” of a multihop chain and a network controller “NC” of a communications network. In relation to CN (100) of FIG. 1, “AN” refers to WCE (110) of MH (130) and “NC” refers to NC (105) of CN (100).

In the operational sequence (200), a multihop contention profile of MH (130) is updated based on a trigger at the anchor node, WCE (110) of MH (130), or on a trigger at the network controller. The MCP trigger (MCP-Trig) (205) occurs at “AN” WCE (110), when there are changes to contention levels resulting from multihop chains. These changes comprise the change in the number of constituting WCEs of MH (110). Such changes affect the contention level for the common CC (125) by MH (130). For example, if a new WCE joins MH (130), there will be more communications exchanged with NC (105). Consequently, contention for common CC (125) will increase. In another example, if an existing WCE disconnects from MH (130), the contention level of MH (130) as a whole is altered as there will be lesser communications with NC (105). Consequently, contention for common CC (125) will decrease.

MCP-Trig (205) may also occur at an anchor node due to other changes, such as changes in the transmission schedule of the multihop chain. For example, if a plurality of anchor nodes from different multihop chains changes their transmission schedules to be concurrent, then the contention level for common CC (125) will increase. In the case of multihop chains operating in accordance with selective distribution of infrastructure (SDI), transmission schedules within each multihop chain alter from infrastructure functions (IF) and client functions (CF). Concurrent access to the common CC (125) occurs when a plurality of anchor nodes operate in CF mode with respect to NC (105).

MCP-Trig (205) occurs at NC (105) when the changes affecting contention arise from NC (105). These changes comprise the change in the number of multihop chains contenting for channel access and the change in the characteristics of the common CC (125). The number of multihop chains contending for channel access is visible by NC (105), so contention increases or decreases in direct relation to the number of multihop chains in CN (100).

After MCP-Trig (205), the anchor node, WCE (110), sends a MCP parameters update (MCP-Param) (210) message to NC (105). This message informs NC (105) of the changes in multihop chains that may affect contention level for common CC (125). MCP-Param (210) comprises the number of WCEs constituting MH (130) and the transmission schedule of the anchor node WCE (110).

Upon receiving MCP-Param (210), NC (105) updates the MCP for MH (130) in a step (215). The updating step (215) comprises updating a single or plurality of MCP parameter values based on MCP-Param (210).

In a step (220), new channel access parameters for MH (130) are calculated in accordance with the current invention. Equation 1 is calculated based on the updated MCP from the updating step (215). Channel access parameters from step (220) represent adjustments to manage changes in contention for common CC (125). So if contention increases in the form of greater number of WCEs in MH (130), then the channel access parameters allow the anchor node, WCE (110), of MH (130) to access common CC (125) for longer duration so as to allow each constituting WCE to exchange communications with NC (105). The step (220) is performed to determine new channel access parameters for both MH (130) and other multihop chains in CN (100). This is because changes in contention level of a first multihop chain have effects on that of other multihop chains in the communications network. The newly calculated channel access parameters comprise TXOP for IEEE 802.11 and IEEE 802.16, channel access priority levels and bandwidth or timeslot reservations. They may also comprise other parameters to manage access to a communications channel.

After new channel access parameters are calculated in a step (220), they are distributed to WCE (110) and other anchor nodes of other multihop chains in CN (100). New channel access parameters are distributed as part of channel access parameters adjustment (ChP-Upd) (225) messages.

Each of the anchor nodes of multihop chains receiving ChP-Upd (225) then performs a parameters updating step (230). In this step, WCE (110) updates its channel access parameters to deal with the new contention level. The step (230) comprises assigning newly received parameter values to the channel access operations. For example, in the case of IEEE 802.11, parameter values received by WCE (110) in ChP-Upd (225) are used in the Protocol_Control, Transmission and Reception Blocks of the state machine to manage communications exchanges over common CC (125).

The messages of sequence (200) may be exchanged in IEEE 802.11 or IEEE 802.16 data frames, specialized control or management frames. They may also be exchanged as payload or in specialized formats of IP or CAPWAP messages.

This embodiment describes the operative steps of the present invention of adjusting channel access based on actual contention in a communications network. It further highlights message exchanges between network controller and anchor nodes. By performing the message exchanges and operations of (200) that are in accordance with the invention, multihop chains and their constituent WCEs will be able to achieve lower delays, greater fairness in communications and higher throughput performance.

### Embodiment 2(B)

### Multiple Radio Channels

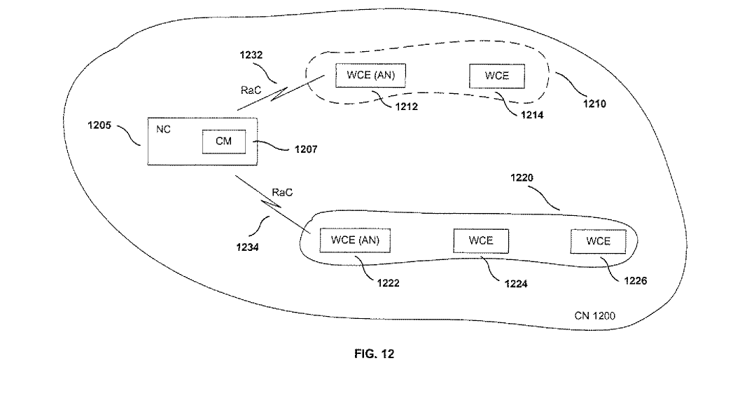

In one embodiment of the invention for managing resource access in a communications network, multihop chains communicate with a network controller over distinct radio communications channels. Communications network CN (1200) of FIG. 12 is illustrative of such a communications network.

NC (1205) is the network controller of CN (1200) and comprises a Controller Module (CM) (1207). CM (1207) is capable of operation in a plurality of radio channels to exchange communications with multihop chains. In an example, CM (1207) is operative in a first IEEE 802.11 radio communications channel, such as 2.412 GHz Channel 01, in a first instance and CM (1207) is operative in a second IEEE 802.11 radio communications channel, such as 2.437 GHz Channel 06, in a second instance. In one aspect of the invention, CM (1207) is simultaneously operative in a plurality of radio communications channels. In an example, CM (1207) realizes a plurality of Medium Access Controller (MAC) functionality operative simultaneously.

CN (1200) comprises 2 multihop chains. MH (1210) comprises WCEs (1212) and (1214), of which WCE (1212) is the anchor node. MH (1220) comprises WCEs (1222), (1224) and (1226), of which WCE (1222) is the anchor node. Anchor node WCE (1212) of MH (1210) communicates with NC (1205) over a Radio Channel (RaC) (1232) and anchor node WCE (1214) of MH (1220) communicates with NC (1205) over a RaC (1234).

Contention arises between anchor nodes WCE (1212) and WCE (1222) for the operations of the common controller module CM (1207). So the common communications resource in CN (1200) is the operative cycles of the controller module of NC (1205). In a given time instance, CM (1207) operates on any one of a plurality of radio communications channels to conduct communications with either of the multihop chains MH (1210) or MH (1220).

In accordance with the present invention for managing contention for common communications resources in a communications network, resource access to the operations of common CM (1207) is based on multihop contention profiles of the multihop chains MH (1210) and MH (1220).

NC (1205) regularly monitors the contention conditions for common CM (1207) from the multihop chains. NC (1205) then updates the multihop contention profiles (MCPs) for each of MH (1210) and MH (1220). The multihop contention profile comprises a plurality of contention parameters such as;

1. Number of anchor nodes of multihop chains simultaneously contending for operations of common CM (1207);
2. Number of WCEs constituting each of multihop chains contending for common CM (1207);
3. Transmission schedule of multihop chains and constituent WCEs;
4. Communications volume exchanged during operations of common CM (1207) in each of plurality of radio communications channels, this may be history or expected communications volume; and
5, Characteristics of common CM (1207), comprising processing load and scheduling mechanism.

Upon updating the multihop contention profiles for the multihop chains in CN (1200), NC (1205) calculates resource access parameters for anchor nodes WCE (1212) and WCE (1214) of the multihop chains. The calculation of resource access parameters is based on Equation 1 using the multihop contention profiles corresponding to contention for common CM (1207).

In one aspect of the embodiment, NC (1205) calculates operating parameters for common CM (1207). The operating parameters are used by CM (1207) to be operative in any of a plurality of radio communications channels. The operating parameters for CM (1207) may comprise the scheduling duration and radio selection schedule. Equation 2 is an algorithmic presentation for calculation of operating parameters such as those described earlier;

$$\begin{matrix}{OP}_{RaC \text{-} x} = f ( {MCP}_{RaC \text{-} x} ) \\ = f ( {nN}_{RaC \text{-} x} , {dOL}_{RaC \text{-} x} ) \\ = ( R 1 \times {nN}_{RaC \text{-} x} ) + ( R 2 \times {dOL}_{RaC \text{-} x} )\end{matrix} \qquad Equation 2$$

wherein, ‘OP_{RaC-x}’ represents the operating parameter being adjusted for controller module operative in radio communications channel, ‘RaC-x’, and ‘MCP_{RaC-x’ is the multihop contention profile for the same radio communications channel.}

‘f ( )’ is a combinative function comprising the factors affecting contention for the controller module operative in ‘RaC-x’.

The parameter ‘nN_{RaC-x}’ is representative of the total number of WCEs comprising that are directly or indirectly communicating with common CM (1207) over radio communications channel ‘RaC-x’. This parameter has a positive relation to ‘OP_{RaCx}’. So where there are many WCEs, CM (1207) is operative in corresponding ‘RaC-x’ mode to allow each WCE to conduct some communications exchanges with the network controller.

The parameter ‘dOL_{RaC-x}’ is representative of the degree of operating load when CM (1207) is operative over radio communications channel ‘RaC-x’. This parameter has a positive relation to ‘OP_{RaC-x}’. So when the operative load is high for ‘RaC-x’, CM (1207) is operative in corresponding ‘RaC-x’ mode for greater duration to compensate for high operating loads.

‘R1’ and ‘R2’ are multiplicative constants for ‘nN_{RaC-x}’ and ‘dOL_{RaC-x}’, respectively. These constants are representative of factors such as weights of the contention parameters.

Equation 2 may comprise alternative or additional parameters such as transmission schedule of multihop chains and their constituent WCEs and volume of communications exchanges. In the case of communications exchange, as volume increases, operating parameters will require to be extended to accommodate greater communications exchanges. So volume of communications exchange has a positive relation to operating parameters of the common controller module.

The parameters of function ‘f ( )’ may also be weighted so as to assign relative degrees of significance in assessing contention for channel access. For example, in Equation 2, the ‘nN_{RaC-x’ parameter may have a weight of} 80% while the ‘dOL_{RaC-x}’ parameter may have a weight of 20%. As a result, operating parameters are calculated to primarily manage contention due to number of WCEs. In this case, parameters ‘R1’ and ‘R2’ are representative of the weights.

Based on Equation 2, the common controller module of the network controller is operative in corresponding radio communications channel modes with anchor nodes of multihop chains of the network. As a result of adjusting operating parameters based on actual contention levels in a communications network, WCEs of MH (1210) and MH (1220) will be able to exchange communications with NC (105) over the common CM (1207). This consequently reduces response times for the multihop chains and improves throughput performance.

### Embodiment 3

### General Block Diagram

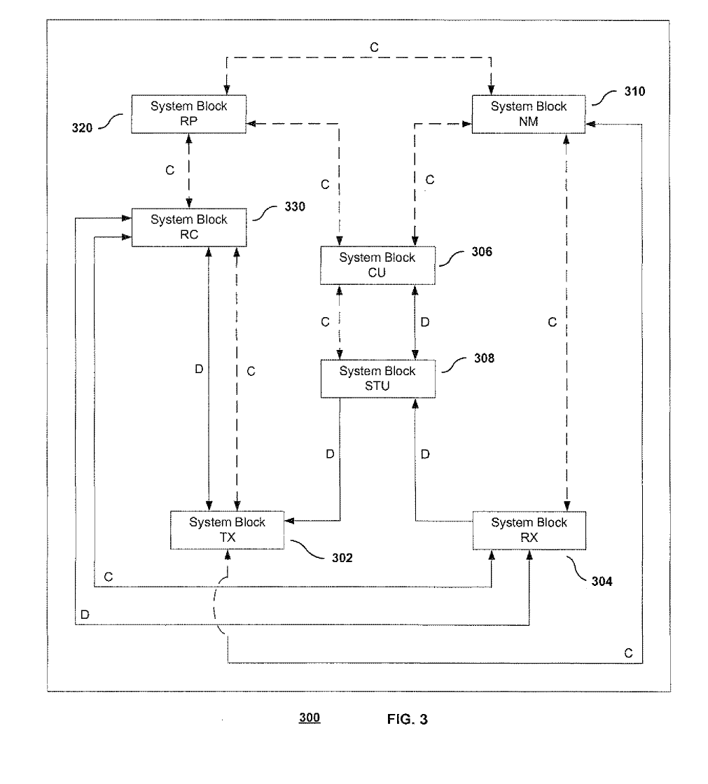

FIG. 3 illustrates an apparatus of a network device, such as network controller NC (105), operating in accordance with the present invention for adjusting channel access.

Network Controller NC (105) comprises a number of system blocks such as resource processor (RP) (320), which performs the operative steps of creating and updating multihop contention profiles for multihop chains in CN (100). It is responsible for monitoring contention levels and for calculating channel access parameters for the common communications channel, CC (125).

The Network Monitor (NM) (310) performs the function of monitoring network conditions affecting contention. For instance, NM (310) monitors the number of multihop chains in CN (100) and the transmission schedules of anchor nodes, such as WCE (110). In another apparatus of the invention, such as WCE (110), NM (310) monitors the number of WCEs constituting a multihop chain such as MH (130) and their respective transmission schedules.

Resource Controller (RC) (330) is responsible for effecting changes in channel access as calculated by RP (320). This comprises adjusting the transmission and reception schedules. In the case of multihop chains with selective distribution on infrastructure, RC (330) is responsible for the scheduling of infrastructure functions (IF) and client functions (CF) modes. RC (330) also adjusts bandwidth reservations.

Transmission Interface (TX) (302) and Reception Interface (RX) (304) are responsible for the exchange of control and data information across the communications channels. TX (302) also performs operation of transmitting changes in channel access parameters to anchor nodes of multihop chains. TX (302) and RX (304) operate in accordance with a single or plurality of communications technologies such as IEEE 802.11, IEEE 802.16, Bluetooth, GSM, WCDMA, CDMA200 and UWB.

The Controlling Unit (CU) (306) system block manages the overall interaction of all system blocks of the network device (300). CU (306) is representative of a main processing unit for the network device.

CU (306) and other system blocks of the network device (300) interact with the Storage Unit (STU) (308) for maintaining information on parameters, processing buffers etc.

The system blocks comprising network device (300) communicate with other system blocks via Control ‘C’ and Data ‘D’ paths. Control paths are used to exchange operative information among the system blocks. Data paths are used to exchange user information among the system blocks.

NM (310) monitors parameters and conditions of the communications network affecting contention levels for the common communications channel, CC (125). MCP-Trig (205) of the operations sequence (200) is issued by NM (310) to RP (320) over the ‘C’ path. MCP-Trig (205) sent by NM (310) comprises information regarding a single or plurality of contention metrics monitored. These contention metrics comprise number of multihop chains, number of WCEs comprising multihop chains and transmission schedules of anchor nodes. NM (310) also sends information on the degree of the contention metric. Contention metrics may be quantified or qualified to reflect the degree of change. For example, NM (310) may indicate the number of new WCEs added to MH (130) or the new higher frequency of transmission of anchor node WCE (110) of MH (130).

Upon receiving MCP-Trig (205) from NM (310), RP (320) updates the MCP for those multihop chains affected by the change in contention. For instance, if a new WCE has joined MH (130), then the contention level of MH (130) will increase due to higher channel access to exchange additional traffic from the new WCE. RP (320) uses Equation 1 to update the channel access parameters for a single or plurality of multihop chain affected by the change in contention levels. For the operative steps of updating MCPs and calculating channel access parameters, RP (320) communicates with CU (306) over the ‘C’ path.

Then after calculation of the channel access parameters, RP (306) sends the parameters to RC (330) to be used by other system blocks of the network device (300). RC (330) coordinates among TX (302) and RX (304) to adjust channel access based on the updated multihop contention profile. For instance, RC (330) may adjust the transmission priorities at TX (302) higher to reflect greater contention. In another example, RC (330) may adjust the scheduler of TX (302) in response to new contention conditions. RC (330) exchanges control and data information with TX (302) and RX (304) over both ‘C’ and ‘D’ paths. RC (330) also sends communications frames comprising updated channel access parameters to TX (302) for transmission to anchor nodes of multihop chains affected by changes in contention. For instance, RC (330) sends an IEEE 802.11 action frame to TX (302) containing updated channel access parameters for MH (130). TX (302) in turn, transmits the IEEE 802.11 action frame to the anchor node WCE (110) of MH (130).

This embodiment illustrates an apparatus in accordance with the invention. The set of system blocks and interactions highlight the design of a network device performing the operative steps of adjusting to changes in contention levels in a communications network.

### Embodiment 4

### IEEE 802.11 Block Diagram

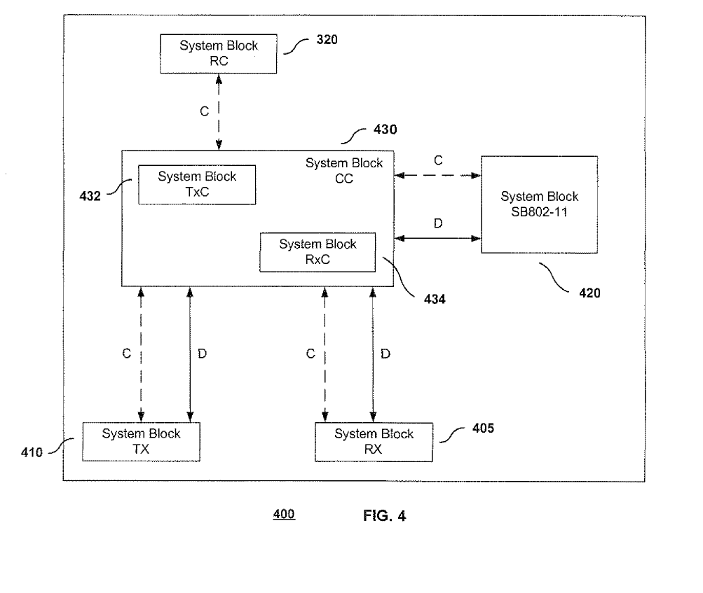

The apparatus illustrated in FIG. 4 is representative of a network device, such as an access controller or wireless access point, operating in accordance with the present invention and in accordance with the IEEE 802.11 communications standard.

Block Reception (RX) (405) and Block Transmission (TX) (410) operate in accordance with IEEE 802.11 communications standard. RX (405) validates incoming frames, decrypts the frames if encrypted and filters duplicate fragments. It also takes in to account inter-frame spacing (IFS) and slot timing. TX (410) performs backoffs based on channel conditions, generates frame check sums (FCS) and inserts timestamps in to frames.

The network device (400) operating in accordance with IEEE 802.11 also comprises System Block 802.11 (SB802-11) (420). SB802-11 (420) comprises MPDU_General, MAC_Data_Service, MAC_Management_Service and other system blocks. The system blocks exchange information via ‘C’ and ‘D’ paths.

RX (405) and TX (410) exchange control and data information with entities external to the network device (400) over IEEE 802.11 communications interfaces.

RX (405) and TX (410) also exchange control and data information internally over ‘C’ and ‘D’ paths with Communications Controller (CC) (430). CC (430) is representative of the Protocol_Control system block.

In accordance with the invention, a new system block is included to that of the IEEE 802.11 apparatus. This new system block is the Resource Processor, RP (320), responsible for monitoring multihop contention profiles of a single or plurality of multihop chains and updating channel access parameters for said multihop chains. RP (320) and CC (430) exchange control information regarding channel access over the ‘C’ path.

CC (430) in turn comprises two system blocks, Transmission Coordinator (TxC) (432) and Reception Coordinator (RxC) (434), representative of Tx_Coordination and Rx_Coordination, respectively, of IEEE 802.11 system blocks CC (430) uses the updated channel access parameters received from RP (320) to manage the operations of TxC (432) and RxC (434). For instance, CC (430) adjusts the transmission schedules to multihop chains based on changes in contention. In another instance, CC (430) increases the priorities for frames to transmit in order to adapt to contention level variations.

CC (430) also constructs IEEE 802.11 action frames that inform receiving IEEE 802.11 network devices on the changes required in their respective channel access operations. These action frames comprise the channel access parameters update (ChP-Upd) (225).

This embodiment illustrates how the IEEE 802.11 communications technology can be extended to benefit from the invention. It highlights how a new system block, Resource Controller (320), can improve communications performance in channel access contention conditions.

### Embodiment 5

### IEEE 802.11 Message Format update

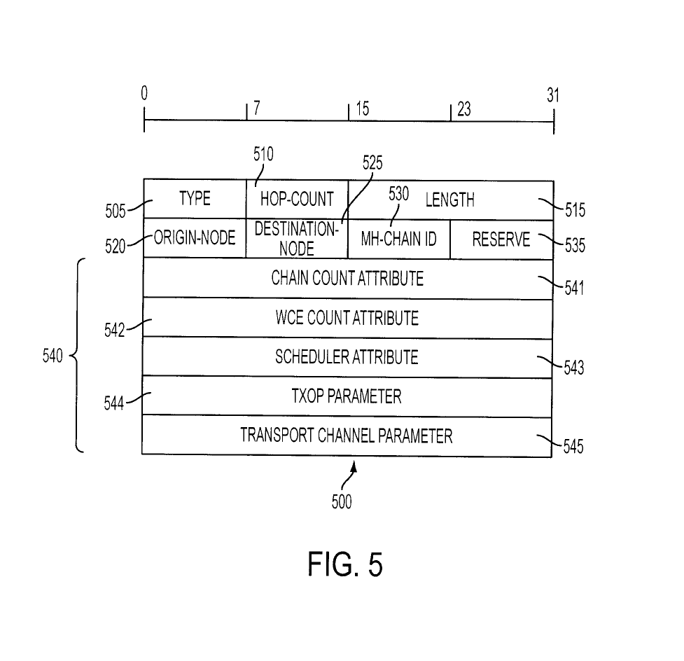

The operations of the disclosed invention may be realized by exchanging messages comprising information on contention levels and updated channel access parameters. The message format (500) for exchanging MCP-Param (210) and Chp-Upd (225) messages between NC (105) and the anchor node WCE (110) of MH (130) is illustrated in FIG. 5. These messages may be transported over other protocols such as IP, TCP, UDP, IETF CAPWAP, IEEE 802.11, IEEE 802.16, GSM and WCDMA. The message format (500) may also be used in with multihop selective distribution of infrastructure functions (SDI) protocol. The message format (500) indicates 8-bytes header followed by a single or plurality of attributes.

The 1-byte Type field (505) denotes the type of SDI message that is exchanged between NC (105) and the anchor node WCE (110). It is assigned a value currently unassigned by the Internet Assigned Numbers Authority (IANA). The value of the Type field (505) may signify any one of MCP-Param (210) or ChP-Upd (225). The Type field (505) is set corresponding values based on the direction of the message exchange, whether from NC (105) to the anchor node WCE (110) or from the anchor WCE (110) to NC (105).

The next 1-byte Hop-Count field (510) signifies the number of hops the message has made so far across the multihop chain from the message originator. The value of this field is incremented by one by each recipient of the message other than the intended final recipient.

The 2-bytes Length field (515) denotes the total length of the message exchanged between NC (105) and anchor node WCE (110) inclusive of the information attributes and channel access parameters.

The Origin Node field (520) signifies the identity of the NC or WCE initiating the message. In the case of MCP-Param (210) sent from anchor node WCE (110) to NC (105), the Origin Node field (520) is assigned the value of identity of WCE (110). In one aspect of the invention, each NC or WCE in a multihop chain is assigned numeric identities. For instance, NC is assigned identity of ‘o’ and each subsequent downstream WCE in the multihop chain is assigned identities of incrementally ascending values, such as ‘1’, ‘2’, ‘3’ etc. In another aspect of the invention, each NC or WCE in a multihop chain is assigned identities based on their respective Medium Access Control (MAC) or Internet Protocol (IP) addresses.

The Destination Node field (525) signifies the identity of the NC or WCE that is the recipient of the message. In the case of MCP-Param (210) sent from anchor node WCE (110) to NC (105), the Destination Node field (525) is assigned the value of identity of NC (105). This field is distinct from the Hop-Count field (510). In one aspect of the invention, the multihop chain entity at which the values of Hop-Count field (510) and Destination Node field (525) match denotes the entity at which the MCP-Param (210) or ChP-Upd (225) message is ultimately processed.

The MH-Chain ID field (530) is a 1-byte field identifying the multihop chain with which a network controller, such as NC (105) exchanges messages with multihop chain's corresponding anchor node, such as WCE (110). In one aspect of the invention, MH-Chain ID (530) is assigned a value based on the MAC address of the network controller interface used for communications with a multihop chain. In another aspect, MH-Chain ID (530) is assigned a unique value by the network controller during the initial exchanges with the anchor node of the multihop chain.

Reserve field (535) is used for exchanging additional information and for future updates to the SDI protocol.

The subsequent fields (540) of the message format (500) illustrate specific attributes or parameters to be used in specific messages for MCP-Param (210) or ChP-Upd (225).

The MCP-Param (210) message comprises attributes such as Chain Count Attribute (541), WCE Count Attribute (542) and Scheduler Attribute (543). These attributes are sent by the anchor node of a multihop chain, such as WCE (110) of MH (130), to the network controller, such as NC (105). The ChP-Upd (225) message comprises parameters such as TXOP Attribute (544) and Transport Channel Attribute (545). These parameters are sent by the network controller, such as NC (105), in response to changes in multihop contention profiles.

The Chain Count Attribute (541) comprises the value for number of multihop chains simultaneously contending for channel access to the common communications channel together with the multihop chain specified by the MH-Chain ID (530) field.

The WCE Count Attribute (542) comprises the value for number of WCEs constituting a multihop chain that directly or indirectly contending for channel access to the common communications channel.

The Scheduler Attribute (543) comprises the values of the transmission schedules of a multihop chain contending for channel access to the common communications channel. In the case of multihop SDI, Scheduler Attribute (543) comprises the value of the schedule of client functions (CF) mode of the anchor node with respect to the network controller.

The TXOP Parameter (544) comprises the value of the channel access parameter based on changes in contention level. TXOP Parameter (544) is applicable for multihop networks operative on the IEEE 802.11 or IEEE 802.16 communications technology standard. The network controller sends TXOP Parameter (544) to the anchor node of the multihop chain specified by the MH-Chain ID field (530).

The Transport Channel Parameter (545) comprises the value of the channel access parameter based on changes in contention level. Transport Channel Parameter (545) is applicable for multihop networks operative on the WCDMA communications technology standard. The network controller sends Transport Channel Parameter (545) to the anchor node of the multihop chain specified by the MH-Chain ID field (530).

This embodiment highlights the message format for the messages exchanged between a network controller and anchor node of multihop chain operating in accordance with the invention for managing channel access based on contention levels. These message exchanges are secured between the Origin Node and Destination Node by suitable security mechanisms.

### Embodiment 6

### CAPWAP

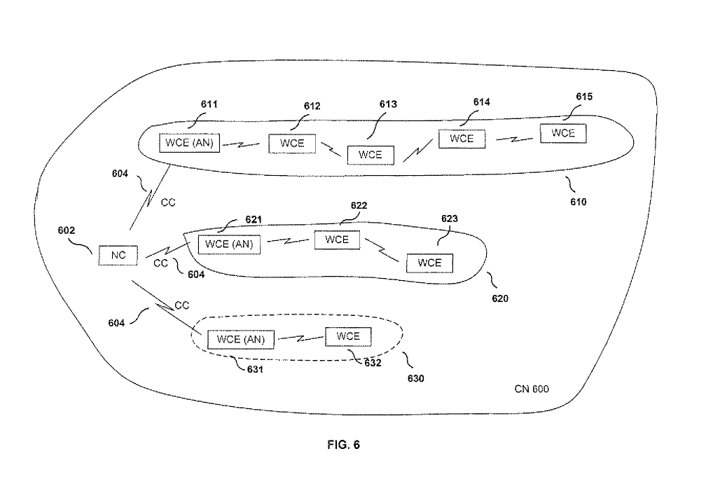

CN (600) of FIG. 6 is illustrative of a communications network with a plurality of multihop chains. CN (600) comprises NC (602), which manages the plurality of WCEs that are organized in a plurality of multihop chains MH (610), (620) and (630). WCEs of the multihop chains directly or indirectly contend for channel access over the common communications channel CC (604). MH (610) comprises WCEs (611), (612), (613), (614) and (615) with WCE (611) as its anchor node. MH (620) comprises WCEs (621), (622) and (623) with WCE (621) as its anchor node. MH (630) comprises WCEs (631) and (632) with WCE (631) as its anchor node.

This current embodiment highlights the operations of the present invention in the scope of the IETF CAPWAP framework. The operations are described with respect to CN (600) and operation sequence (700).

In a step (705), multihop chains MH (610), (620) and (630) and their constituting WCEs establish and maintain CAPWAP associations with NC (602). In the step (705), multihop chains MH (610), (620) and (630) are configured, provisioned and monitored. In this step (705), new initial configuration parameters may be exchanged, WCEs may be authenticated and associated with corresponding multihop chains.

When there is a change in network conditions leading to change in contention for CC (604), a multihop contention profile trigger, MCP-Trig (205) occurs at the anchor nodes WCE (611), (621) and (631) of MH (610), (620) and (630), respectively. MCP-Trig (205) may also occur at NC (602).

Then in a step (710), anchor nodes of the multihop chains exchange CAPWAP Contention Updates (710) with NC (602). CARWAP Contention Updates (710) comprise multihop contention profile parameters, MCP-Param (210) as monitored by anchor nodes WCE (611), (621) and (631). In addition to generic MCP parameters, such as number of constituting WCEs in a multihop chain, CAPWAP Contention Updates (710) also comprise parameters relating to the operating network environment. These operating network environment parameters comprise channel or multihop interference levels and number of wireless stations associated with each constituting WCE of a multihop chain.

After the completion of CAPWAP Contention Updates (710), NC (602) performs the step of updating multihop contention profiles (215) for each of the multihop chains MH (610), (620) and (630). The MCP updating step (215) takes in to consideration both general MCP-Param (210) and specific CAPWAP operating network environment parameters.

In a step (220), NC (602) calculates new channel access parameters for multihop chains MH (610), (620) and (630) based on changes in contention levels. This calculation step (220) is based on Equation 1 and comprises the change in number multihop chains and their constituting WCEs, directly or indirectly contending for channel access over the common communications channel CC (604). The channel access parameters in the CAPWAP framework comprises the schedule for WCEs of multihop chains operating in accordance with CAPWAP and the schedule for WCEs operating in accordance with an alternative mechanism. For instance, a WCE operates in accordance with CAPWAP when communicating with a network controller and the WCE may also operate in accordance with a relay mechanism such as one in accordance with IEEE 802.16j, mobile multihop relay. WCEs operate in alternative schedules as a result of which, contention for the common communication channel varies. These variations are captured by the current invention and corresponding channel access parameters are calculated. Through the current invention, WCEs of multihop chains can achieve significant QoS performance by negating adverse effects of alternating contention levels.

After calculating new channel access parameters for multihop chains MH (610), (620) and (630), NC (602) exchanges CAPWAP Channel Access Updates (715) messages with the multihop chains. CAPWAP Channel Access Updates (715) notify the multihop chains of new channel access parameters to be used to contend for channel access to the common communications channel (604). They also comprise updates to the operative schedules used by anchor nodes and other constituent WCEs of the multihop chains MH (610), (620) and (630).

Anchor nodes WCE (611), (621) and (631) receiving CAPWAP Channel Access Updates (715) and utilize the parameters to update their respective channel access operations in a step (230). In one instance of the parameters update step (230), an anchor node increase their transmission power in accordance with an updated multihop contention profile managed by NC (602). In another instance of step (230), an anchor node increases transmission priority level of its communications messages in accordance with an updated multihop contention profile managed by NC (602).

In one aspect of the invention for adjusting channel access based on contention level in a multihop communications network, the parameters update step (230) is performed simultaneously among a plurality of anchor nodes WCE (611), (621) and (631) of multihop chains MH (610), (620) and (630). In this aspect, NC (602) and the WCEs constituting multihop chains are in time coordination. The time coordination comprises external coordination such as GPS synchronization and intrinsic coordination such as timing signals. In another aspect of the present invention, the parameters update step (230) is performed non-simultaneously among a plurality of anchor nodes of the multihop chains.

After channel access parameters have been updated by anchor nodes and other constituent WCEs of multihop chains of CN (600), the anchor nodes begin operations for channel access to the common communications channel CC (604) in a step (720). The channel access step (720) is based on the updated channel access parameters and operative schedules received from NC (602).

This embodiment is illustrative of the operations of the present invention in the CAPWAP framework. It highlights the new exchanges performed by CAPWAP nodes such as anchor nodes, WCEs constituting multihop chains and network controller. The invention for adapting channel access for multihop chains may thus be embodied in the CAPWAP protocol and framework.

### Embodiment 7

### CAPWAP Message Format

Message format (800) is illustrative of the CAPWAP messages exchanged among NC (602), anchor nodes WCE (611), (621) and (631) and other constituent WCEs of multihop chains MH (610), (620) and (630). The Version field (805) indicates the version of the CAPWAP protocol used. Flags field (810) comprises a single of plurality of flags used to denote specific characteristics of the message exchanges. These characteristics comprise the design of access points, the type of Medium Access Control (MAC) design, the nature of CAPWAP message—either control or data, retransmission marking and encryption mode. The next Length field (815) denotes the length of the CAPWAP message.

The Hop-Count field (820) indicates the number of multihop chain hops related to the CAPWAP message. In the downstream direction, Hop-Count (820) indicates the number of multihop chain hops required to reach the destination of the CAPWAP message. In the upstream direction, Hop-Count (820) indicates the number of multihop chain hops made from the source of the CAPWAP message. In the present invention, CAPWAP messages sent by NC (602) to anchor nodes WCE (611), (621) and (630) and other constituent WCEs of multihop chains MH (610), (620) and (630) will have Hop-Count (820) value of “1”, which will be decremented upon receipt by the anchor nodes and processed. Similarly, CAPWAP messages sent by the anchor nodes of MH (610), (620) and (630) to NC (602) will have Hop-Count (820) value of “1”, which will be decremented upon receipt by NC (602) and processed.

The next Message-Type field (825) denotes the type of CAPWAP message. The type comprises Discovery, Discover Response, Configuration Request, Configuration Response, Synchronization, Key Config, Key Config Response, Capabilities, Capabilities Response, Terminal Addition/Deletion, Terminal Addition/Deletion Response, Notification, Notification Response, Feedback and Feedback Response. In accordance with the present invention, CAPWAP messages also comprise Contention Update, Contention Update Response, Channel Access Update and Channel Access Update Response. Each message type is distinguished by a code.

MH-Chain ID field (830) identifies the multihop chain within which the CAPWAP message is exchanged. The value may be assigned by NC (602) when multihop chains are established.

The following Reserve field (835) is used for additions to the CAPWAP message. The Payload fields (840) comprise all additional message elements relating to the type of CAPWAP message. The Payload field (840) content varies for each type of CAPWAP message.

In accordance with the present invention, the Payload field (840) for CAPWAP Contention Update message (710) comprises Chain Count Attribute (541), WCE Count Attribute (542) and Scheduler Attribute (543). The Payload field (840) for CAPWAP Channel Access Update message (715) comprises Transmission Power Parameter (841) and Scheduler Parameter (842).

This embodiment highlights the message format for the present invention in the CAPWAP framework.

### Embodiment 8

### Operations Flowchart

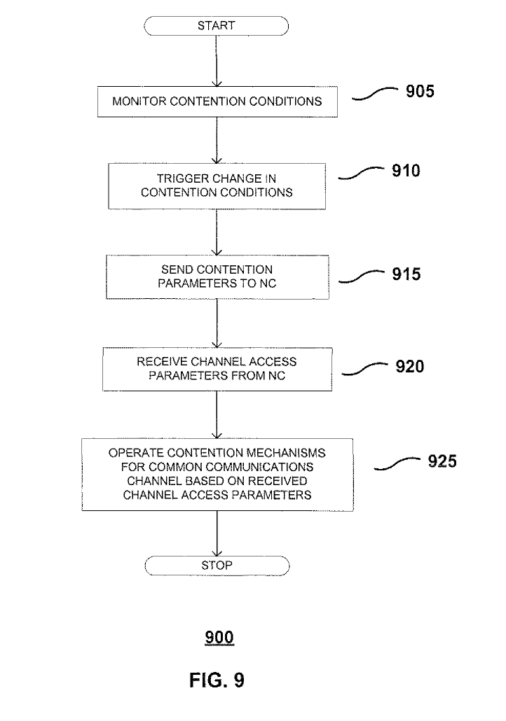

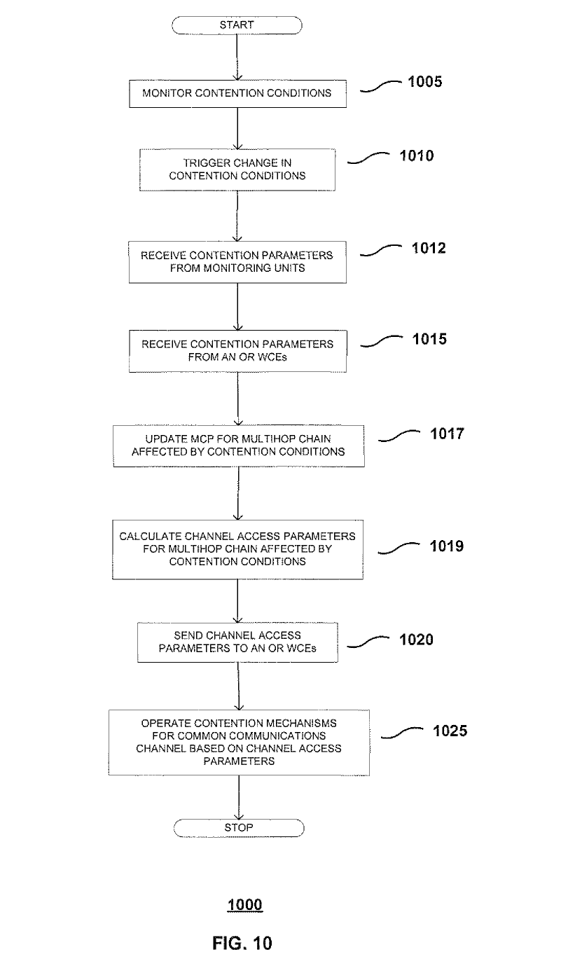

Flowchart (900) of FIG. 9 and flowchart (1000) of FIG. 10 illustrate steps performed by anchor nodes and other constituent WCEs of multihop chains and network controller, respectively, in accordance with the present invention for adjusting channel access in multihop networks based on contention levels for a common communications channel.

Operations of anchor nodes and other WCEs constituent of multihop chains (900) comprise performing a step (905) of monitoring contention conditions over a common communications channel with a network controller. The step (905) comprises monitoring WCEs associating and disassociating with a multihop chain and the operative schedules of constituent WCEs. In one aspect of the invention, monitoring step (905) is performed by a dedicated system unit constituting anchor nodes and other WCEs constituent of a multihop chain. In another aspect, monitoring step (905) is performed by a plurality of system units.

Operations of network controller (1000) comprise performing a step (1005) of monitoring contention conditions over a common communications channel with a network controller. The step (1005) comprises monitoring the number of multihop chains and operative schedules of multihop chains contending for channel access over the common communications channel with the network controller. When there is a change in contention conditions monitored by anchor nodes and other constituent WCEs of multihop chains, a trigger step (910) occurs. A trigger step (1010) occurs at the network controller when there is a change in contention conditions monitored by the network controller. After a trigger step (910) at a multihop chain, the anchor node of the multihop chain sends the network controller information regarding the change in contention conditions in a step (915). The step (915) comprises sending parameters representative of contention levels to the network controller. The step (915) is sent over communications protocols such as IEEE 802.11, IEEE 801.16, GSM, GPRS, WCDMA and CAPWAP.

After a trigger step (1010) at a network controller, the network controller receives information regarding the nature of the change in contention conditions from a single or plurality of monitoring units in a step (1012). In a step (1015), the network controller receives the contention parameters sent by anchor nodes in a step (915).

After receiving information regarding changes in contention conditions from steps (1012) and (1015), the network controller updates the multihop contention profile for the multihop chain, for which contention conditions have been affected, in a step (1017). The updating step (1017) is performed for a single or plurality of multihop chains affected by changes in contention conditions.

After the updating step of (1017), the network controller calculates channel access parameters for the multihop chains affected by changes in contention conditions in a step (1019). The calculation step (1019) is based on the parameters affected similar to Equation 1.

The updated channel access parameters are then sent to the anchor nodes and other constituent WCEs of multihop chains in a step (1020). The channel access parameters of the step (1020) are sent over communications protocols such as IEEE 802.11, IEEE 801.16, GSM, GPRS, WCDMA and CAPWAP. The updated channel access parameters are received by the anchor nodes and other constituent WCEs of multihop chains in a step (920).

In steps (925) and (1025), anchor nodes and other constituent WCEs of multihop chains and the network controller operate their respective contention mechanisms for the common communications channel based on updated channel access parameters.

This embodiment of functional flows of the current invention highlights the operative steps. It illustrates the relative steps performed by a network controller and anchor nodes and other constituent WCEs of multihop chains operating in accordance with the invention. The embodiment is illustrative of the QoS performance benefits derived from adjusting channel access based on contention conditions in multihop networks.

### Embodiment 9

### Network Cameras

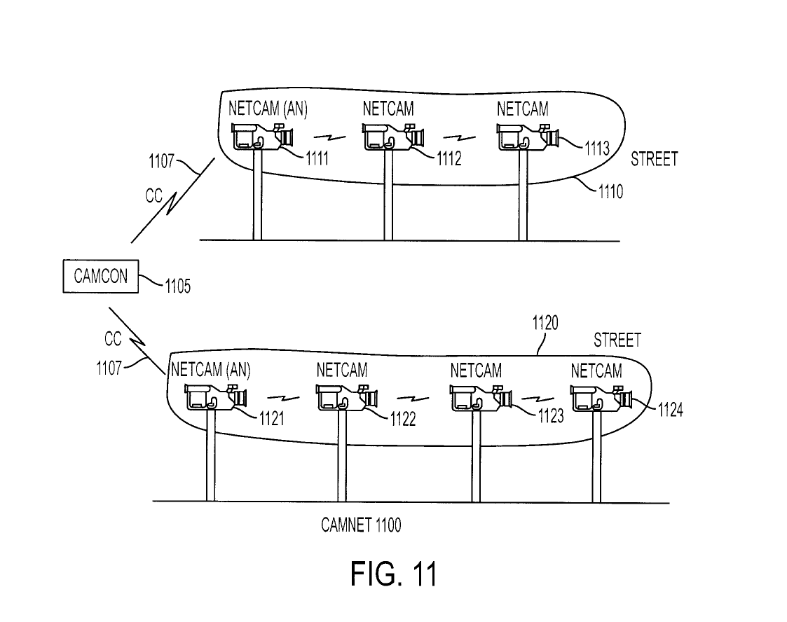

The present invention for adjusting channel access based on contention conditions is applicable to many deployment scenarios. FIG. 11 illustrates the embodiment of the invention in a scenario of wireless network cameras. Camera Network (CamNet) (1100) is illustrative of a network of cameras communicating with each other and also with a Camera Controller (CamCon) (1105). Network cameras (NetCam) (1111), (1112), (1113), (1121), (1122), (1123) and (1124) may be installed on streetlight posts or other locations. The cameras may provide surveillance function for public streets, housing and commercial areas.

The network cameras are configured as multihop chains with respect to CamCon (1105). In one aspect of the embodiment, network cameras are configured based on the street on which the cameras are deployed. Multihop chain Street (1110) comprises NetCam (1111), (1112) and (1113). NetCam (1111) is the anchor node for multihop chain Street (1110). Multihop chain Street (1120) comprises NetCam (1121), (1122), (1123) and (1124). NetCam (1121) is the anchor node for multihop chain Street (1120).

Network cameras of CamNet (1100) transmit their images from one camera to another to CamCon (1105). Multihop chains, Street (1110) and Street (1120), encounter varying contention conditions when different network cameras power on and transmit images. As a result contention for channel access over the common communications channel (CC) (1107) to CamCon (1105) is dynamic.

In accordance with the invention, anchor nodes NetCam (1111) and NetCam (1121) of multihop chains Street (1110) and Street (1120), respectively, monitor contention conditions for the common communications channel CC (1107). A change in contention conditions triggers a contention update, which is sent by the anchor nodes NetCam (1111), NetCam (11210) to CamCon (1105).

Upon receiving contention parameters from the anchor nodes NetCam (1111), NetCam (11210), CamCon (1105) updates the multihop contention profiles for their respective multihop chains. Then based on the updated multihop contention profiles, CamCon (1105) calculates channel access parameters for anchor nodes NetCam (1111) and NetCam (1121) and other respective NetCams of multihop chains Street (1110) and Street (1120).

The updated channel access parameters are then sent to the anchor nodes and other NetCams of multihop chains Street (110) and Street (1120). The network cameras of the multihop chains then operate based on the updated channel access parameters.

This embodiment highlights the invention for adjusting channel access based on contention conditions in multihop networks. The advantage of the invention is the enhanced QoS performance realized by the network cameras operating in an environment with varying contention levels. As a result images from the network cameras will be exchanged consistently.

The aforementioned embodiments of the invention illustrate the applications of the invention for adjusting channel access based on contention conditions of multihop communications networks. The embodiments show how the invention helps to adapt to changes in contention conditions and enhance communications QoS performance.

1. A system for managing access to a communications resource in a communications network comprising,
i. means for monitoring a single or plurality of contention conditions;
ii. means for monitoring contention profiles of a single or plurality of communicating entities; and
iii. means for calculating resource access parameters;
whereby, said calculated resource access parameters are used by a single or plurality of communicating entities to contend for resource access to said communications resource.

2. The system according to claim 1 wherein said contention conditions comprise number of configurations of communicating entities contending for resource access, number of communicating entities comprising said configurations of communicating entities, operating schedules of said communicating entities, transmission opportunities and transmission characteristics of said communicating entities.

3. The system according to claim 2 wherein said configurations of communications entities comprises multihop configurations.

4. The system according to claim 1 wherein said communications resource comprises communications channel.

5. The system according to claim 1 wherein said communications resource comprises operations of controller module.

6. A system for managing resource access to a communications resource in a communications network comprising;
i. means for calculating effect of contention conditions on communications performance; and
ii. means for adjusting resource access parameters based on said calculated effect;
whereby, communicating entities contend for resource access to said communications resource with said adjusted resource access parameters.

7. The system according claim 6 wherein said communicating entities adjust said resource access parameters to reduce communications response time.

8. The system according claim 6 wherein said communicating entities adjust said resource access parameters to increase communications throughput.

9. A system for managing resource access to a communications resource in a communications network comprising means for calculating contention conditions in said communications network, whereby, said contention conditions comprise direct and indirect contention conditions for resource access to said communications resource.

10. The system according to claim 9 wherein said calculation of contention conditions comprises parameters of number of configurations of communicating entities contending for resource access and number of communicating entities comprising each of said configurations of communicating entities.

11. A system for managing resource access to a communications resource in a communications network comprising means for aggregating contention conditions of a plurality of communications entities contending for said communications resource, whereby said aggregated contention conditions are maintained by a single or plurality of communications entities.

12. The system according to claim 11 wherein said aggregated contention conditions are indicative of direct or indirect contention for said communications resource, whereby resource access parameters are adjusted in relation to the aggregated contention conditions.

13. A method for managing resource access to a communications resource in a communications network comprising,
i. monitoring a single or plurality of contention conditions;
ii. monitoring contention profiles of a single or plurality of communicating entities; and
iii. calculating resource access parameters;
whereby, said calculated resource access parameters are used by a single or plurality of communicating entities to contend for resource access to said communications resource.

14. The method according to claim 13 wherein said contention conditions comprise number of configurations of communicating entities contending for resource access, number of communicating entities comprising said configurations of communicating entities, operating schedules of said communicating entities, transmission opportunities and transmission characteristics of said communicating entities.

15. The method according to claim 14 where in said configurations of communications entities comprises multihop configurations.

16. The method according to claim 13 wherein said communications resource comprises communications channel.

17. The method according to claim 13 wherein said communications resource comprises operations of controller module.

18. A method for managing resource access to a communications resource in a communications network comprising;
i. calculating effect of contention conditions on communications performance; and
ii. adjusting resource access parameters based on said calculated effect;
whereby, communicating entities contend for resource access to said communications resource with said adjusted channel access parameters.

19. The method according claim 18 wherein said communicating entities adjust said resource access parameters to reduce communications response time.

20. The method according claim 18 wherein said communicating entities adjust said resource access parameters to improve communications throughput.

21. A method for managing resource access to a communications resource in a communications network comprising calculating contention conditions in said communications network, whereby, said contention conditions comprise direct and indirect contention conditions for resource access to said communications resource.

22. The method according to claim 21 wherein said calculation of contention conditions comprises parameters of number of configurations of communicating entities contending for resource access and number of communicating entities comprising each of said configurations of communicating entities.

23. A method for managing resource access to a communications resource in a communications network comprising aggregating contention conditions of a plurality of communications entities contending for said communications resource, whereby said aggregated contention conditions are maintained by a single or plurality of communications entities.

24. The method according to claim 23 wherein said aggregated contention conditions are indicative of direct or indirect contention for said communications resource, whereby resource access parameters are adjusted in relation to the aggregated contention conditions.
